(19) United States
(12) Patent Application Publication
(10) Pub. No.: US 2003/0115130 A1
(43) Pub. Date: Jun. 19, 2003

(54) Percent to double option chain calculator

(76) Inventor: Walter Lee Stump, W. St. Paul, MN (US)

Correspondence Address: Walter Lee Stump, 1744 Richard Circle, W. St. Paul, MN, 55118, US

(21) Appl. No.: 10/263,130

(22) Filed: Oct. 2, 2002

Related U.S. Application Data
(60) Provisional application No. 60/345,290, filed on Oct. 25, 2001.

(51) Int. Cl. G06F 17/60

(52) U.S. Cl. 705/37

(57) ABSTRACT

By using the option chain data from DTNIQ©, the “Percent to double chain calculator” gives the investors something they have never had before. The ability to find the best options for a stock being traded, using a calculator that displays the options that will have the highest return for the least amount of movement in the underlying stock price. A calculator that does it in less than two seconds for the entire option chain.

### BACKGROUND OF INVENTION

This invention relates to stock option trading. By using option chain data from a data provider the “Percent to double chain calculator” gives investors something they have never had before; the ability to find the options that will have the highest rate of return for the least amount of movement in the underlying stock price. The “Percent to double chain calculator” does it for the entire option chain in less than 2 seconds.

Previously to get the percent to double you first had to calculate the Delta for each option. Delta is the change in the price of an option for a one point move in the underlying stock . . . example with a delta of 0.5, if the stock moved $1.00 the option value would move $0.50. Then by using a standard electronic calculator you entered in the data for a specific option. Example: you enter the (Option ask price−Option bid price)+Option ask price divided by the Delta. This equals the stock movement that is needed. Then divide the stock movement by the current stock price. This will then give you the percentage the stock has to move for the option value to double. With up to 100 or more different options for a single stock, it makes it very time consuming to find the best option to trade. The “Percent to Double Calculator” takes the time out of the problem.

### BRIEF DESCRIPTION OF THE DRAWINGS

FIG. 1 is an example of “Load Option Chain ” screen

FIG. 2 is an example of the calculator requesting the stock price..

FIG. 3 is an example of the calculator after the stock price has been entered.

FIG. 4 is an example of a parameter entry screen with parameters entered for manually entered percent to double.

FIG. 5 is an example listing of an option chain with percent to double for calls listed.

### DETAILED DESCRIPTION OF THE INVENTION

### Percent to Double Chain Calculator

Percent to Double is the Percentage Movement of the Price of the Stock that is Needed for the Price of the Stock Option to Double in Value

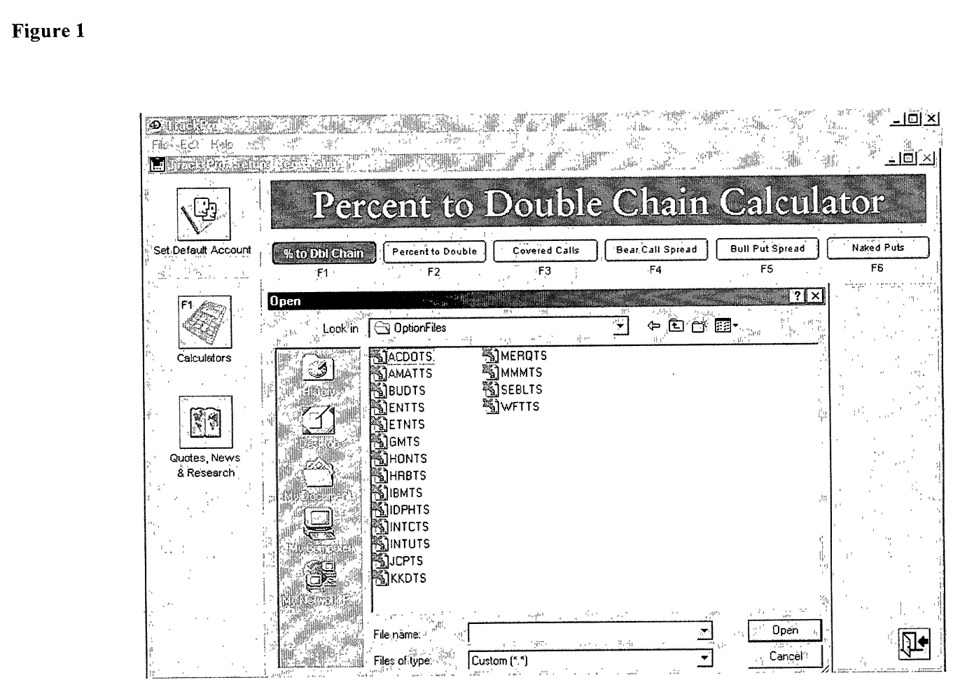

Start Track Pro. Press the “F1″ key, then the “F1″ key again, then press the “Load Option Chain” button. This will open the Option File folder showing you the option chains you have saved. You will notice that the letters TS appear as the last two letters on all of the files. The first letters are actually the Stock Symbol. See FIG. 1.

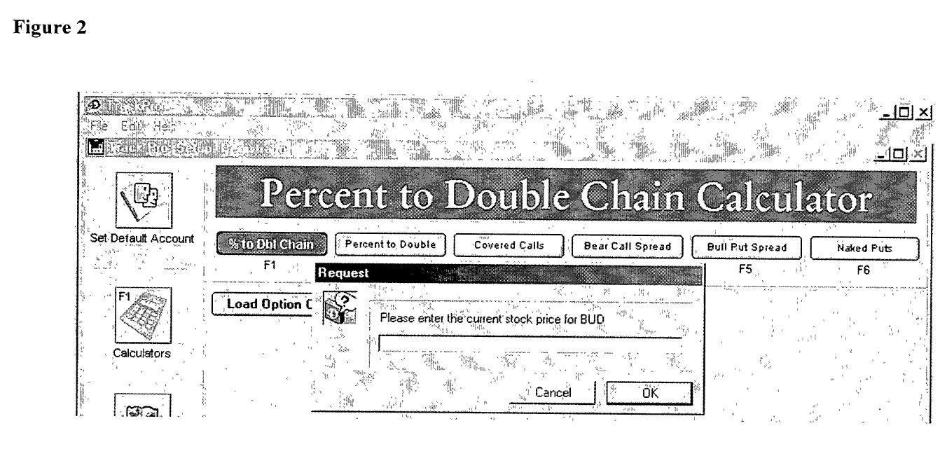

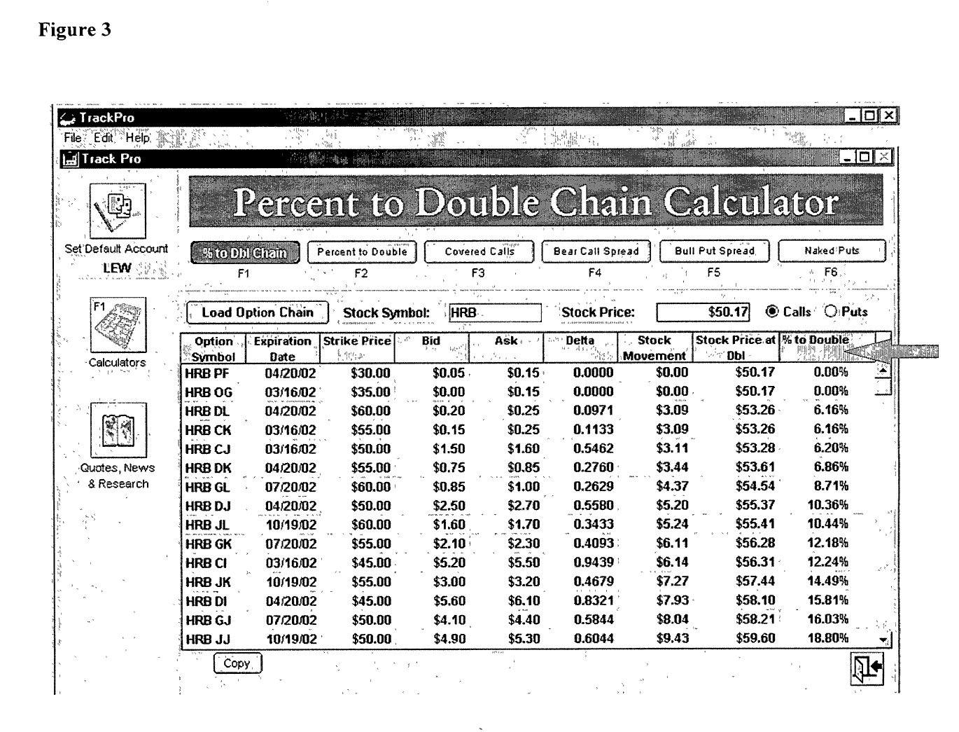

Double click on the stock you wish to run the calculation on and the program will ask you to enter the price of the stock when you saved the option chain. See FIG. 2. When the calculation is done, double click on the “% to Double” column header and the data sheet will be sorted by that column. You can also sort by double clicking on any other column headers. See FIG. 3.

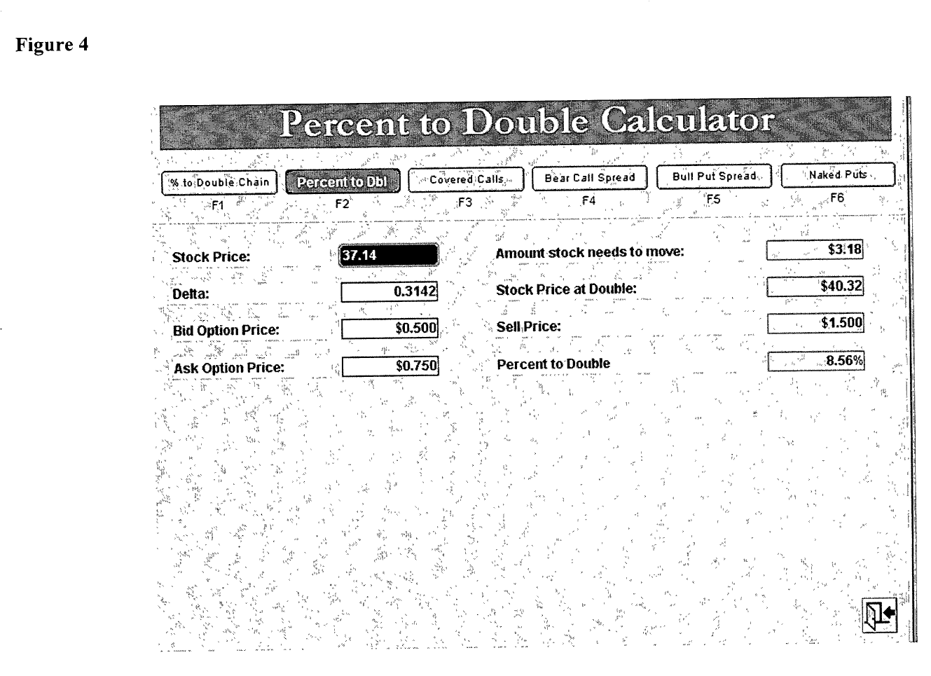

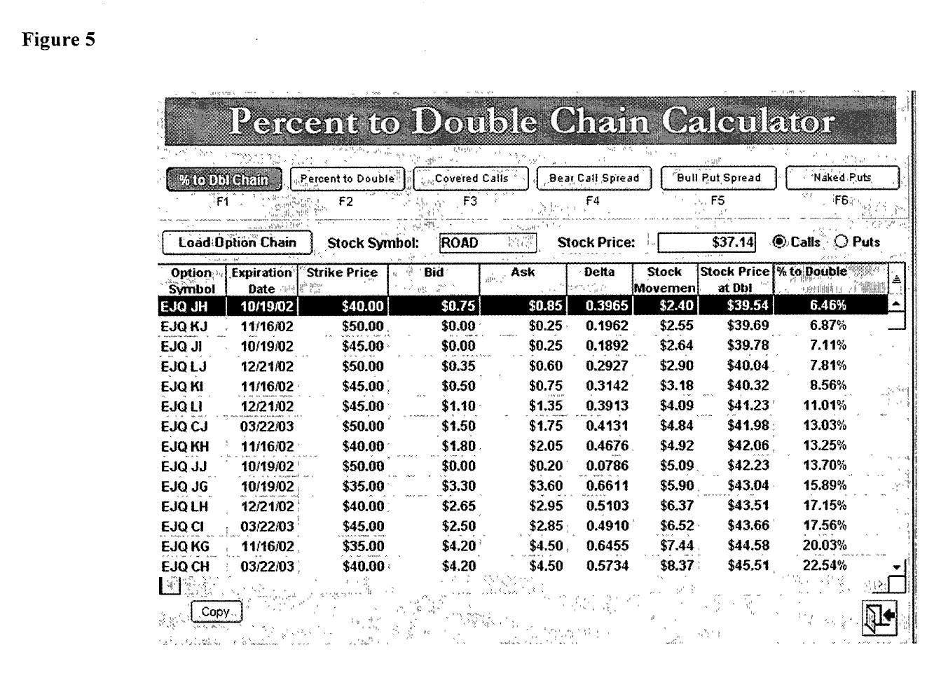

Specifically, the present invention enables a user to determine those stock options that have the smallest percent to double by executing the following formula (The parameters of the formula are manually entered for FIG. 4 and entered by the program from a data source for FIG. 5):

(A−B)+A/C=D, then D/E=Percent to Double

A=Option ask Price

B=Option bid price

C=Delta

D=Stock movement needed

E=Stock price

An example parameter-entry screen with parameters is depicted in FIG. 4

An example of the chain calculator with data chain parameters is depicted in FIG. 5

A user of this unique invention may find what the percent to double is of any particular option at any time by downloading an entire option chain automatically into the program. The user can then examine all options for the underlying stock. By looking at all options for a stock sorted by percent to double, a user can pick the best option that meets their other requirements such as strike date, strike price, and delta, see FIG. 5.

While the percent to double may be determined manually on a calculator, the present invention allows a user to review an individual option very quickly by entering the stock price, delta, option ask price, and option bid price. This gives the user a true percent to double as far as being able to buy the option and to sell the option at a true double.

What is claimed:

1. This calculator displays the options that will have the highest return for the least amount of movement for the underlying stock price. A percent to double calculator software program as substantially described and depicted herein.

2. This gives investors a calculation for the entire option chain. A method of evaluating stock options as substantially described and depicted herein.
